(19) United States
(12) Patent Application Publication
(10) Pub. No.: US 2011/0192241 A1
(43) Pub. Date: Aug. 11, 2011

(54) VEHICLE-COLLISION SIMULATION TESTING APPARATUS

(76) Inventor: Junichi AIKI, Tokyo (JP)

(21) Appl. No.: 13/023,325

(22) Filed: Feb. 8, 2011

(30) Foreign Application Priority Data
Feb. 10, 2010 (JP) 2010-027891

(51) Int. Cl. G01M 17/00

(52) U.S. Cl. 73/865.3

(57) ABSTRACT

[Object] In a vehicle-collision simulation testing apparatus, to make it possible to downsize the apparatus with lightweight.

[Solution] A sled 11 is supported in a movable manner in a back-and-forth direction, a yawing sled 14 is arranged on the sled 11 in a horizontally rotatable manner with a front portion supported by a rotation shaft, on which a product under test can be mounted, an eccentric mass 17 is arranged on a side of a rotation shaft on the yawing sled 14, and a launching device 18 that applies a backward acceleration on a front side of the sled 11.

### TECHNICAL FIELD

The present invention relates to a vehicle-collision simulation testing apparatus for replicating an acceleration generated inside a vehicle at the time of a collision and replicating damage on a passenger by a secondary collision, without destroying the vehicle.

### BACKGROUND ART

Generally, a collision test of a vehicle is conducted by a full-scale collision test for evaluating a physical amount such as a crash amount and a residual space amount inside a vehicle and a damage value on a passenger. However, a method of taking a dummy on a real vehicle and colliding the vehicle into a barrier at a predetermined speed is a destructive test, which requires a very high cost. Therefore, a vehicle-collision simulation test is performed instead by loading a white body equipped with a dummy, an airbag and the like and a simulation vehicle (hereinafter, “product under test”) on a dolly and applying an acceleration with substantially the same level as in a real vehicle collision on the dolly, thus replicating an impact exerted on the product under test in a nondestructive manner and evaluating a damage value on a passenger, to develop safety devices such as airbags.

A vehicle-collision simulation testing apparatus for conducting such a vehicle-collision simulation test is described in, for example, Patent Literature 1 mentioned below. In the vehicle-collision simulation testing apparatus described in Patent Literature 1, a front end of a middle sled is supported by a sled that is slidable in a back-and-forth direction in a vertically and horizontally rotatable manner, a product under test is loaded on the middle sled, and the sled that is stopped is launched in a backward direction by an actuator, by which an acceleration at the time of a vehicle collision is applied to the product under test.

### CITATION LIST

### [Patent Literature]

[PTL 1] JP 2006-138701A

### SUMMARY OF INVENTION

### Technical Problem

However, in the conventional vehicle-collision simulation testing apparatus described above, an overhanging portion is provide on a side of the middle sled and the product under test is loaded on the overhanging portion in an offset state, to perform a yawing operation of the product under test by the middle sled making a horizontal rotation when an acceleration is applied to the middle sled by the actuator. As a result, the side of the middle sled is largely overhung, causing a problem of large-sizing.

The present invention has been achieved to solve the above problem, and an object of the present invention is to provide a vehicle-collision simulation testing apparatus that can be downsized with lightweight.

### Solution to Problem

A vehicle-collision simulation testing apparatus includes: a pedestal that is supported in a movable manner in a back-and-forth direction; a yawing sled arranged on the pedestal in a horizontally rotatable manner with a front portion supported by a rotation shaft, on which a product under test can be mounted; an eccentric weight unit arranged on a side of a rotation shaft on the yawing sled; and an accelerating device that applies a backward acceleration on a front side of the pedestal.

Therefore, it is possible to conduct a yawing operation of a product under test in a vehicle-collision simulation test simply by providing the eccentric weight unit at a predetermined position on the yawing sled, which makes it possible to prevent the yawing sled itself from large-sizing, thus downsizing the apparatus with lightweight.

Advantageously, in the vehicle-collision simulation testing apparatus, a substantially center position of the yawing sled in a left-and-right direction is supported in a horizontally rotatable manner around the rotation shaft.

Therefore, it is possible to suppress an increase of the size of the yawing sled.

Advantageously, in the vehicle-collision simulation testing apparatus, the product under test is mounted at an offset position on a side on the yawing sled, and the eccentric weight unit is arranged on an end of a front side of the yawing sled in a direction of offsetting the product under test.

Therefore, it is possible to perform an appropriate yawing operation on the product under test by mounting the eccentric weight unit at an optimum position on the yawing sled, which makes it possible to make the eccentric weight unit lighter.

Advantageously, in the vehicle-collision simulation testing apparatus, the yawing sled is formed in a rectangular shape, and the eccentric weight unit is fixed within an upper surface of the yawing sled.

Therefore, a protrusion or the like is not necessary on an outer circumferential side of the yawing sled by fixing the eccentric weight unit inside the upper surface of the yawing sled, thus eliminating an obstacle in the vehicle-collision simulation test, which makes it possible to conduct the test in an appropriate manner.

Advantageously, the vehicle-collision simulation testing apparatus further includes a breaking device that breaks a horizontal rotation of the yawing sled.

Therefore, it is possible to perform an appropriate yawing operation on the product under test by the breaking device.

Advantageously, in the vehicle-collision simulation testing apparatus, the breaking device includes a damper.

Therefore, it is possible to achieve a simple structure with a low cost by using the breaking device as a damper.

Advantageously, in the vehicle-collision simulation testing apparatus, the breaking device include a hydraulic damper and a control device that hydraulically controls the hydraulic damper in response to an operation of the accelerating device.

Therefore, it is possible to increase the testing accuracy by performing an optimum yawing operation on the product under test.

Advantageously, the vehicle-collision simulation testing apparatus further includes: a rotational-force applying unit that can apply a rotational force on the yawing sled; and a control device that operates the rotational-force applying unit in conjunction with an operation of the accelerating device.

Therefore, it is possible to perform the yawing operation on the product under test by causing the breaking device to operate the rotational-force applying unit in conjunction with an operation of the accelerating device together with the eccentric weight unit in the vehicle-collision simulation test, which makes it possible to downsize the eccentric weight unit with lightweight.

### Advantageous Effects of Invention

According to the vehicle-collision simulation testing apparatus according to the present invention, because an eccentric weight unit is provided on a side of a rotation shaft of a yawing sled on which a product under test is loaded, it is possible to perform a yawing operation on the product under test with a simple structure, which makes it possible to downsize the apparatus with lightweight.

### BRIEF DESCRIPTION OF DRAWINGS

FIG. 1 is a side view of a vehicle-collision simulation testing apparatus according to a first embodiment of the present invention.

FIG. 2 is a plan view of the vehicle-collision simulation testing apparatus according to the first embodiment.

FIG. 3 is a plan view of an operation of the vehicle-collision simulation testing apparatus according to the first embodiment.

FIG. 4 is a plan view of a vehicle-collision simulation testing apparatus according to a second embodiment of the present invention.

FIG. 5 is a side view of a vehicle-collision simulation testing apparatus according to a third embodiment of the present invention.

FIG. 6 is a side view of a vehicle-collision simulation testing apparatus according to a fourth embodiment of the present invention.

FIG. 7 is a plan view of the vehicle-collision simulation testing apparatus according to the fourth embodiment.

FIG. 8 is a plan view of a vehicle-collision simulation testing apparatus according to a fifth embodiment of the present invention.

FIG. 9 is a plan view of a vehicle-collision simulation testing apparatus according to a sixth embodiment of the present invention.

### DESCRIPTION OF EMBODIMENTS

Exemplary embodiments of a vehicle-collision simulation testing apparatus according to the present invention will be explained below in detail with reference to the accompanying drawings. The present invention is not limited to the embodiments.

### First Embodiment

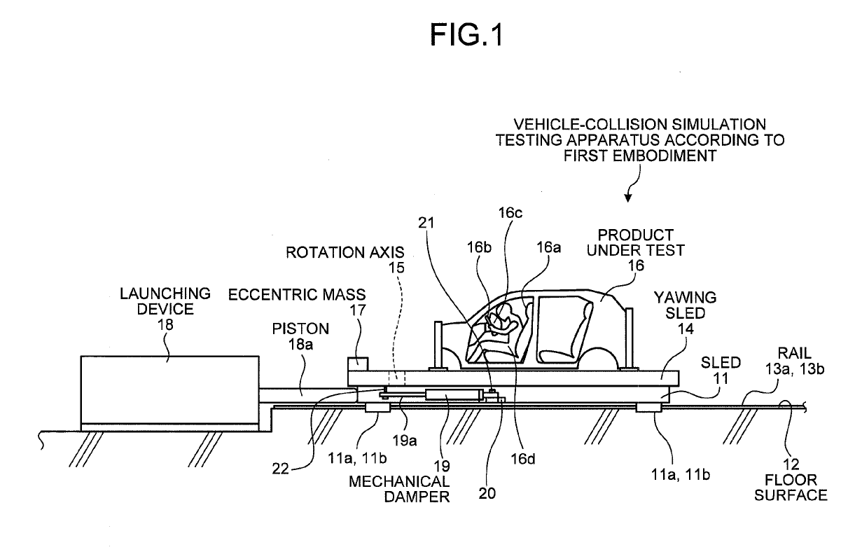

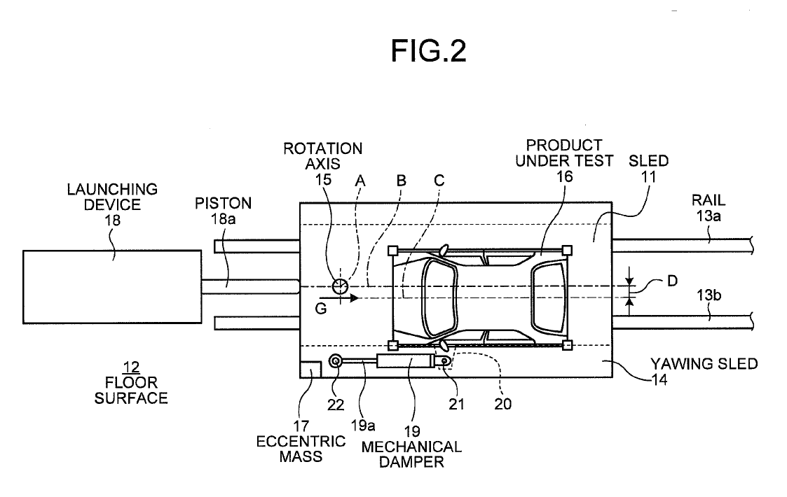

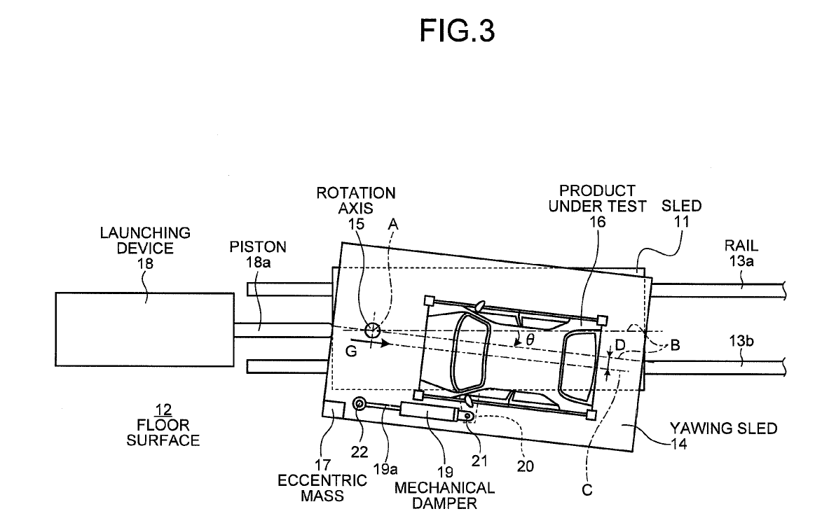

FIG. 1 is a side view of a vehicle-collision simulation testing apparatus according to a first embodiment of the present invention, FIG. 2 is a plan view of the vehicle-collision simulation testing apparatus according to the first embodiment, and FIG. 3 is a plan view of an operation of the vehicle-collision simulation testing apparatus according to the first embodiment.

In the vehicle-collision simulation testing apparatus according to the first embodiment, as shown in FIGS. 1 and 2, a sled 11 as a pedestal is a frame having a predetermined thickness, forming a rectangular shape elongated in a back-and-forth direction in its planar view (the horizontal direction in FIGS. 1 and 2). A pair of right and left rails 13a and 13b with a predetermined distance is installed on a floor surface 12 along the back-and-forth direction, so that the sled 11 is supported in a movable manner along the rails 13a and 13b via sliders 11a and 11b fixed on its bottom surface.

A yawing sled 14 is, similarly to the sled 11, a frame having a plate member with a predetermined thickness, forming a rectangular shape elongated in a back-and-forth direction in its planar view (the horizontal direction in FIGS. 1 and 2). The width of the yawing sled 14 in a left-and-right direction is wider than that of the sled 11, while the length of the yawing sled 14 in the back-and-forth direction is substantially the same as that of the sled 11. The yawing sled 14 is arranged on the sled 11, with a front portion supported by the sled 11 via a rotation axis 15. That is, the rotation axis 15 includes a rotation shaft A along the vertical direction, passes through the yawing sled 14 and the sled 11 from above, and supports both the yawing sled 14 and the sled 11 in a rotatable manner respect to each other. With this arrangement, the yawing sled 14 is supported in a horizontally rotatable manner around the rotation shaft A.

The yawing sled 14 is configured such that a product under test 16 is mounted thereon. In the present embodiment, the product under test 16 is a vehicle with only a frame, that is, a so-called white body. In the product under test 16, automotive trims such as a seat 16a, a steering wheel 16b, and an airbag 16c are installed as well as a dummy 16d. The product under test 16 is located at a predetermined position on the yawing sled 14, and is fixed by a fixture (not shown).

In the present embodiment, because the product under test 16 is mounted on the yawing sled 14, a front side of a vehicle, which is the product under test 16, (the left direction in FIGS. 1 and 2) is explained as a front side of the sled 11 and the yawing sled 14, and a rear side of the vehicle, which is the product under test 16, (the right direction in FIGS. 1 and 2) is explained as a rear side of the sled 11 and the yawing sled 14. Likewise, sides of the vehicle, which is the product under test 16, that is, the left-and-right direction of the vehicle (the upward direction and the downward direction in FIGS. 1 and 2) is explained as sides of the sled 11 and the yawing sled 14, that is, the left-and-right direction of the sled 11 and the yawing sled 14.

In the vehicle-collision simulation testing apparatus according to the present embodiment, because it is necessary to perform a yawing operation on the product under test 16, the product under test 16 is mounted on the yawing sled 14 at an offset position on one side. That is, the yawing sled 14 is supported on the sled 11 such that a substantially center position in the left-and-right direction is horizontally rotatable around the rotation axis 15 (the rotation shaft A). The product under test 16 is fixed on the yawing sled 14 at a position with a substantially center position in the left-and-right direction shifted on a side direction (the left direction) from the rotation axis 15 (the rotation shaft A). That is, an offset amount D is set between a centerline B passing through the rotation axis 15 (the rotation shaft A) on the yawing sled 14 along the back-and-forth direction and a centerline C on the product under test 16 along the back-and-forth direction.

The rotation center A is a center position of a rotation (yawing) when a vehicle collides into a barrier in a full-scale collision test. In practice, it is a colliding position between a front end of an engine and an internal steel beam of an 0 DB aluminum honeycomb material. Therefore, in consideration of this configuration, a mounting position of the product under test 16 on the yawing sled 14 is set.

An eccentric mass 17 as an eccentric weight unit is provided on the yawing sled 14 on a side of the rotation axis 15 (the rotation shaft A). Although a rotating force (a yawing operation) is exerted on a vehicle together with a backward acceleration of the vehicle in a real offset collision of the vehicle, in the vehicle-collision simulation testing apparatus according to the present embodiment, because a weight of the yawing sled 14 hinders this rotating force, the eccentric mass 17 is provided to promote a rotation of the yawing sled 14. Therefore, the eccentric mass 17 is arranged on a front side of the yawing sled 14 and at a side end of the yawing sled 14 in a direction of offsetting the product under test 16. In this case, it is preferable that the eccentric mass 17 be arranged on a side of the rotation shaft A that is perpendicular to the centerline B on the yawing sled 14 and on an outermost side of the yawing sled 14 in the left-and-right direction. In the present embodiment, considering a position where mounting can be conducted easily and a position that does not hinder the collision test, the eccentric mass 17 is fixed on an upper surface of the yawing sled 14 at a front end and at a side edge on the left side where the product under test 16 is arranged in an offset state.

A mounting position and a weight of the eccentric mass 17 is set based on a temporal change (waveform) of a yawing angle from known parameters including, for example, design data of the sled 11 and the yawing sled 14 (weight, position of the center of gravity and the like) and an acceleration change and a change of the yawing angle in a collision time obtained from the full-scale collision test.

A launching device 18 is installed on the floor surface 12 on a front side of the sled 11 and the yawing sled 14, as an accelerating device that applies a backward acceleration on the sled 11. The launching device 18 includes a piston 18a that is launched toward the sled 11 by being hydraulically controlled (or air-pressure controlled or friction controlled). By launching the piston 18a in a state where a distal end of the piston 18a has contact with the front end of the sled 11, it is possible to apply a backward impact, that is, a backward acceleration on the sled 11. That is, the application of the backward acceleration on the sled 11 by the launching device achieves the same effect as a reception of a forward acceleration when the product under test 16 on the yawing sled 14 collides in the forward direction, making it possible to generate a vehicle collision accident in a simulative manner.

A mechanical damper 19 is installed between the sled 11 and the yawing sled 14, as a breaking device to break a horizontal rotation of the yawing sled 14. The mechanical damper 19 is arranged on a side of the sled 11 where the product under test 16 is arranged in an offset state. That is, the mechanical damper 19 is connected to a mounting bracket 20 that is formed by a back end of a main body thrusting from a side end portion of the sled 1 by the mounting shaft 21 in a rotatable manner, while a distal end of a piston rod 19a is connected to a bottom surface of the yawing sled 14 by a mounting shaft 22 in a rotatable manner.

While the mechanical damper 19 for breaking the horizontal rotation of the yawing sled 14 is provided, a stopper (not shown) for stopping the horizontal rotation of the yawing sled 14 at a predetermined angle is provide on the sled 11. It is preferable that this stopper be arranged for both the left rotation direction and the right rotation direction of the yawing sled 14.

An operation of the vehicle-collision simulation testing apparatus according to the first embodiment described above is explained below.

When conducting a vehicle collision test by the vehicle-collision simulation testing apparatus according to the first embodiment, a launching force of the piston 18a in the launching device 18 and a position of the product under test 16 on the yawing sled 14 are set to predetermined values in advance, in order to replicate a temporal change (waveform) of a yawing angle from the design data of the sled 11 and the yawing sled 14 (weight, position of the center of gravity and the like) and an acceleration change and a change of the yawing angle in a collision time obtained from the full-scale collision test.

First, as shown in FIG. 2, the launching device 18 is hydraulically controlled in a state where the yawing sled 14 and the product under test 16 are arranged in parallel to the sled 11 to launch the piston 18a, so that a target acceleration (a backward acceleration in the sled 11, the yawing sled 14, and the product under test 16) G is applied on the sled 11 that is in a stopped state to apply the acceleration G at the time of a collision on the product under test 16.

The sled 11 then moves, as shown in FIG. 3, in the backward direction according to the applied target acceleration G, and in a state where the sled 11 moved in the backward direction by a predetermined distance, the yawing sled 14 conducts a yawing operation around the rotation axis 15 (the rotation shaft A). That is, the yawing sled 14 makes a horizontal rotation in a clockwise direction in FIG. 3 around the rotation axis 15 (the rotation shaft A) so that its end portion moves in the left direction. With this operation, it is possible to apply a predetermined yawing operation on the product under test 16 that is fixed on the yawing sled 14.

At this time, with the yawing operation on the yawing sled 14 and the product under test 16, the mechanical damper 19 is operated to break the rotation of the yawing sled 14. Therefore, the yawing sled 14 is rotated in the horizontal direction by a yawing angle θ, by which the yawing operation is applied on the product under test 16.

As described above, in the vehicle-collision simulation testing apparatus according to the first embodiment, the sled 11 is supported in a movable manner in the back-and-forth direction, the front portion of the yawing sled 14 on which the product under test 16 can be mounted is supported on the sled 11 in a horizontally rotatable manner by the rotation shaft A, the eccentric mass 17 is provided on the side of the rotation shaft A, and the launching device 18 that applies the backward acceleration is arranged on the forward side of the sled 11.

Therefore, it is possible to apply the yawing operation on the product under test 16 in the vehicle-collision simulation test simply by fixing the eccentric mass 17 at a predetermined position on the yawing sled 14, without providing an overhanging portion on the yawing sled 14 itself to cause an increase of the size of the apparatus, and as a result, it is possible to downsize the apparatus with lightweight. In this case, because the mounting position and the weight of the eccentric mass 17 is set based on known parameters, a rotation response matches a target rotation waveform in the whole time range, which eliminates the necessity of providing a servo device or its control.

In the vehicle-collision simulation testing apparatus according to the first embodiment, because the yawing sled 14 is supported such that the substantially center position in the left-and-right direction is horizontally rotatable around the rotation axis 15 by the rotation shaft A, it is possible to suppress an increase in size of the yawing sled 14.

In the vehicle-collision simulation testing apparatus according to the first embodiment, the product under test 16 is mounted at an offset position on the side on the yawing sled 14, and the eccentric mass 17 is installed on the front side of the yawing sled 14 and at the side end of the yawing sled 14 in the direction of offsetting the product under test 16. Therefore, it is possible to apply an appropriate yawing operation on the product under test 16 by arranging the eccentric mass 17 at an optimum position on the yawing sled 14, and at the same time, it is possible to reduce the weight of the apparatus by reducing the weight (mass) of the eccentric mass 17.

In the vehicle-collision simulation testing apparatus according to the first embodiment, the yawing sled 14 is formed in a rectangular shape, and the eccentric mass 17 is fixed on the upper surface of the yawing sled 14. Therefore, it does not necessitate a protrusion or the like on the outer circumference of the yawing sled 14 because the eccentric mass 17 is fixed within the upper surface of the yawing sled 14, eliminating an obstacle in the vehicle-collision simulation test, and as a result, it is possible to conduct the test in an appropriate manner.

In the vehicle-collision simulation testing apparatus according to the first embodiment, the mechanical damper 19 is installed as the breaking device for breaking the horizontal rotation of the yawing sled 14. Therefore, it is possible to apply an appropriate yawing operation on the product under test 16 by the mechanical damper 19, and at the same time, it is possible to simplify the structure of the apparatus and to reduce the cost.

### Second Embodiment

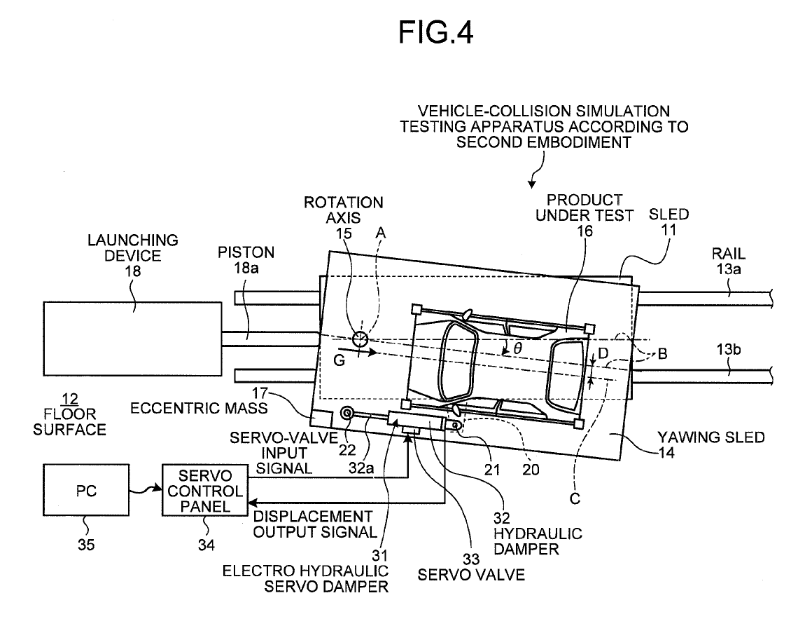

FIG. 4 is a plan view of a vehicle-collision simulation testing apparatus according to a second embodiment of the present invention. Members having functions identical to those described in the above embodiment are denoted by like reference numerals and redundant explanations thereof will be omitted.

As shown in FIG. 4, in the vehicle-collision simulation testing apparatus according to the second embodiment, the sled 11 is supported in a movable manner along a pair of right and left rails 13a and 13b installed on the floor surface 12. The yawing sled 14 is arranged on the sled 11, with a front portion supported by the sled 11 via the rotation axis 15 so that it can make a rotation in the horizontal direction around the rotation shaft A. The product under test 16 can be mounted on an upper surface of the yawing sled 14 with a predetermined offset amount D.

The eccentric mass 17 is provided on the yawing sled 14 on a side of the rotation axis 15 (the rotation shaft A). The eccentric mass 17 is fixed on the yawing sled 14 at a front end and at a side edge on the side where the product under test 16 is arranged in an offset state.

The launching device 18 is installed on a front side of the sled 11 and the yawing sled 14, as an accelerating device that applies a backward acceleration on the sled 11. The launching device 18 includes the piston 18a that is launched toward the sled 11 by being hydraulically controlled. By launching the piston 18a in a state where a distal end of the piston 18a has contact with the front end of the sled 11, it is possible to apply a backward impact, that is, a backward acceleration on the sled 11.

An electrohydraulic servo damper 31 is installed between the sled 11 and the yawing sled 14, as a breaking device to break a horizontal rotation of the yawing sled 14. The electrohydraulic servo damper 31 is arranged on a side direction of the sled 11 where the product under test 16 is arranged in an offset state. That is, the electrohydraulic servo damper 31 includes a hydraulic damper 32 and a servo valve 33, and a back end portion of the hydraulic damper 32 is connected to the mounting bracket 20 of the sled 11 by the mounting shaft 21 in a rotatable manner, while a distal end of a piston rod 32a is connected to a bottom surface of the yawing sled 14 by the mounting shaft 22 in a rotatable manner.

The servo valve 33 regulates an oil amount for the hydraulic damper 32 and is connected to a control device (a computer or PC) 35 via a servo control panel 34. The design data of the sled 11 and the yawing sled 14 (weight, position of the center of gravity and the like) and an acceleration change and a change of the yawing angle in a collision time obtained from the full-scale collision test are input to the control device 35, and the control device 35 controls the servo control panel 34 based on the input data, to break the yawing sled 14, so that a temporal change (waveform) of a yawing angle is replicated. In this case, the servo control panel 34 outputs a servo-valve input signal to the servo valve 33 in response to a displacement output signal form the hydraulic damper 32.

The launching device 18 then launches the piston 18a, so that a target acceleration G is applied to the sled 11 that is in a stopped state to apply the acceleration G at the time of a collision on the product under test 16. The sled 11 moves in the backward direction according to the applied target acceleration G, and in a state where the sled 11 moved in the backward direction by a predetermined distance, the yawing sled 14 conducts a yawing operation around the rotation axis 15 (the rotation shaft A). At this time, the control device 35 controls the electrohydraulic servo damper 31 to replicate the temporal change (waveform) of the yawing angle. That is, the control device 35 adjusts a breaking force of the hydraulic damper 32 by adjusting an opening of the servo valve 33 via the servo control panel 34, and breaks the yawing sled 14 in an appropriate manner to apply the yawing operation on the product under test 16 such that the yawing sled 14 is rotated in the horizontal direction by a yawing angle θ.

As described above, in the vehicle-collision simulation testing apparatus according to the second embodiment, the sled 11 is supported in a movable manner in the back-and-forth direction, the front portion of the yawing sled 14 on which the product under test 16 can be mounted is supported on the sled 11 in a horizontally rotatable manner by the rotation shaft A, the eccentric mass 17 is provided on the side of the rotation shaft A, the launching device 18 that applies the backward acceleration is arranged on the forward side of the sled 11, and the electrohydraulic servo damper 31 is provided as a breaking device for breaking the horizontal rotation of the yawing sled 14.

Therefore, it is possible to apply the yawing operation on the product under test 16 in the vehicle-collision simulation test simply by fixing the eccentric mass 17 at a predetermined position on the yawing sled 14, without providing an overhanging portion on the yawing sled 14 itself to cause an increase of the size of the apparatus, and as a result, it is possible to downsize the apparatus with lightweight. Furthermore, it is possible to apply an optimum yawing operation on the product under test 16 by the electrohydraulic servo damper 31, and as a result, it is possible to enhance the accuracy of the test.

### Third Embodiment

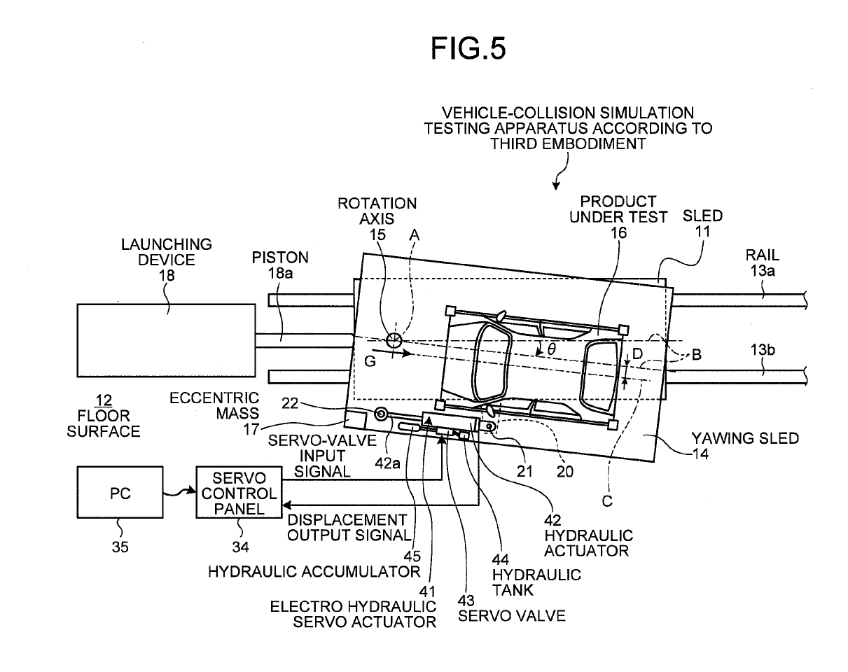

FIG. 5 is a side view of a vehicle-collision simulation testing apparatus according to a third embodiment of the present invention. Members having functions identical to those described in the above embodiments are denoted by like reference numerals and redundant explanations thereof will be omitted.

As shown in FIG. 5, in the vehicle-collision simulation testing apparatus according to the third embodiment, the sled 11 is supported in a movable manner along a pair of right and left rails 13a and 13b installed on the floor surface 12. The yawing sled 14 is arranged on the sled 11, with a front portion supported by the sled 11 via the rotation axis 15 so that it can make a rotation in the horizontal direction around the rotation shaft A. The product under test 16 can be mounted on an upper surface of the yawing sled 14 with a predetermined offset amount D. The eccentric mass 17 is further provided on the yawing sled 14 on a side of the rotation axis 15 (the rotation shaft A).

The launching device 18 is installed on a front side of the sled 11 and the yawing sled 14, as an accelerating device that applies a backward acceleration on the sled 11. The launching device 18 includes the piston 18a that is launched toward the sled 11 by being hydraulically controlled. By launching the piston 18a in a state where a distal end of the piston 18a has contact with the front end of the sled 11, it is possible to apply a backward impact, that is, a backward acceleration on the sled 11.

An electrohydraulic servo actuator 41 is installed between the sled 11 and the yawing sled 14, as a rotational-force applying unit that can apply a rotational force on the yawing sled 14. The electrohydraulic servo actuator 41 is arranged on a side of the sled 11 where the product under test 16 is arranged in an offset state. That is, the electrohydraulic servo actuator 41 includes a hydraulic actuator 42, a servo valve 43, a hydraulic tank 44, and a hydraulic accumulator 45, and a back end portion of the hydraulic actuator 42 is connected to the mounting bracket 20 of the sled 11 by the mounting shaft 21 in a rotatable manner, while a distal end of a piston rod 42a is connected to a bottom surface of the yawing sled 14 by the mounting shaft 22 in a rotatable manner.

The servo valve 43 regulates an oil amount for the hydraulic actuator 42 and is connected to a control device (a computer or PC) 35 via the servo control panel 34. The design data of the sled 11 and the yawing sled 14 (weight, position of the center of gravity and the like) and an acceleration change and a change of the yawing angle in a collision time obtained from the full-scale collision test are input to the control device 35, and the control device 35 controls the servo control panel 34 based on the input data in conjunction with an operation of the launching device 18, to apply a rotational force (a rotation torque) on the yawing sled 14, so that a temporal change (waveform) of a yawing angle is replicated.

It is possible to use the electrohydraulic servo actuator 41 as a breaking device for the yawing sled 14.

The launching device 18 then launches the piston 18a, so that a target acceleration G is applied to the sled 11 that is in a stopped state to apply the acceleration G at the time of a collision on the product under test 16. At this time, the control device 35 controls the electrohydraulic servo actuator 41 in conjunction with an operation of the launching device 18 to replicate the temporal change (waveform) of the yawing angle. That is, the control device 35 adjusts a driving force of the hydraulic actuator 42 by adjusting an opening of the servo valve 43 via the servo control panel 34, and applies an appropriate rotational acceleration on the yawing sled 14. The sled 11 moves in the backward direction according to the applied target acceleration G, and in a state where the sled 11 moved in the backward direction by a predetermined distance, the yawing sled 14 conducts a yawing operation around the rotation axis 15 (the rotation shaft A), by which the yawing sled 14 is rotated in the horizontal direction by a yawing angle θ.

As described above, in the vehicle-collision simulation testing apparatus according to the third embodiment, the sled 11 is supported in a movable manner in the back-and-forth direction, the front portion of the yawing sled 14 on which the product under test 16 can be mounted is supported on the sled 11 in a horizontally rotatable manner by the rotation shaft A, the launching device 18 that applies the backward acceleration is arranged on the forward side of the sled 11, and the electrohydraulic servo actuator 41 is provided between the sled 11 and the yawing sled 14, which applies a rotational force on the yawing sled 14 in conjunction with the launching device 18.

Therefore, it is possible to apply the yawing operation on the product under test 16 in the vehicle-collision simulation test by simply providing the electrohydraulic servo actuator 41 that applies a rotational force on the yawing sled 14, without providing an overhanging portion on the yawing sled 14 itself to cause an increase of the size of the apparatus, and as a result, it is possible to downsize the apparatus with lightweight.

Furthermore, it is possible to apply an optimum yawing operation on the product under test 16 by the electrohydraulic servo actuator 41, and as a result, it is possible to enhance the accuracy of the test. In addition, it is possible to downsize the eccentric mass 17 installed on the yawing sled 14 with lightweight.

### Fourth Embodiment

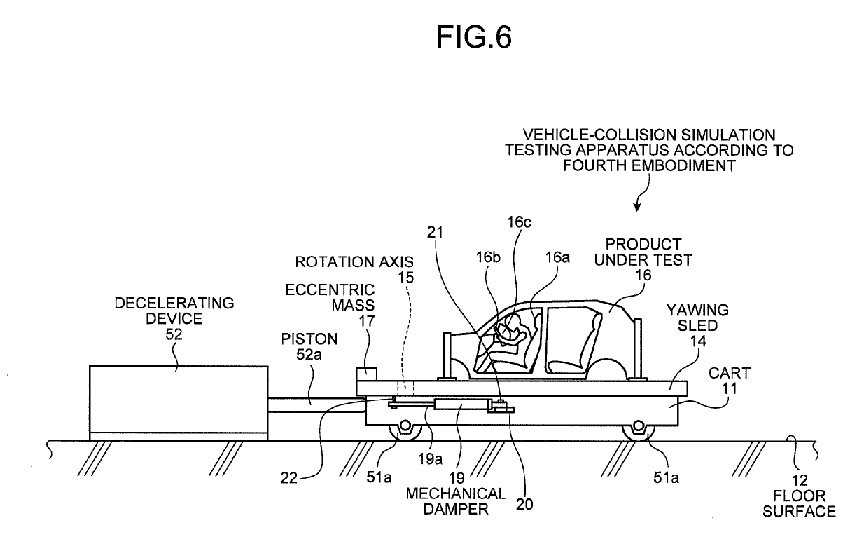

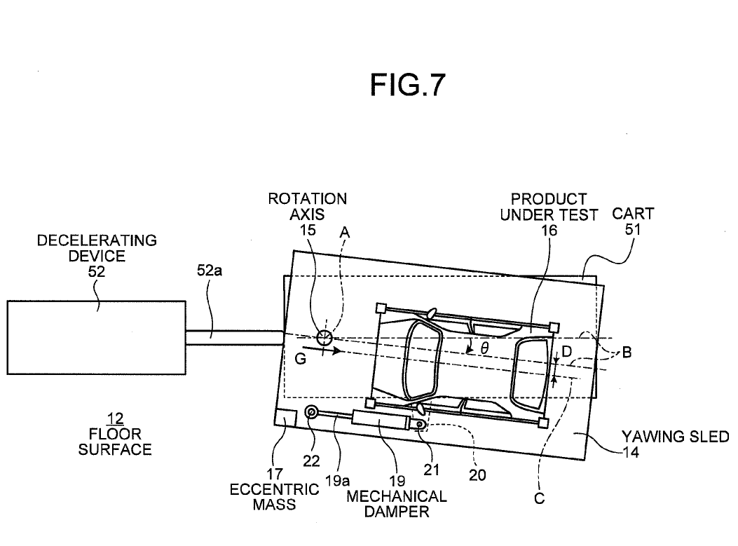

FIG. 6 is a side view of a vehicle-collision simulation testing apparatus according to a fourth embodiment of the present invention, and FIG. 7 is a plan view of the vehicle-collision simulation testing apparatus according to the fourth embodiment. Members having functions identical to those described in the above embodiments are denoted by like reference numerals and redundant explanations thereof will be omitted.

As shown in FIGS. 6 and 7, in the vehicle-collision simulation testing apparatus according to the fourth embodiment, a cart 51 as a pedestal is a dolly having a predetermined thickness, forming a rectangular shape elongated in a back-and-forth direction in its planar view (the horizontal direction in FIGS. 6 and 7). Four wheels 51a are installed at front/rear and left/right of a lower surface portion of the cart 51. In this case, the cart 51 is capable of moving back and forth on the floor surface 12 by a driving device (not shown). In this case, although the cart 51 is towed by a motor-driven winch, it can be a self-running type with a built-in motor. The yawing sled 14 is arranged on the cart 51, with a front portion supported by the cart 51 via the rotation axis 15 so that it can make a rotation in the horizontal direction around the rotation shaft A. The product under test 16 can be mounted on an upper surface of the yawing sled 14 with a predetermined offset amount D.

The eccentric mass 17 is provided on the yawing sled 14 on a side of the rotation axis 15 (the rotation shaft A). The eccentric mass 17 is fixed on the yawing sled 14 at a front end and at a side edge on the side where the product under test 16 is arranged in an offset state.

A decelerating device 52 is installed on a front side of the sled 11 and the yawing sled 14, as an accelerating device that applies a backward acceleration on the cart 51. The decelerating device 52 includes a piston 52a that is retracted in a direction opposite to the cart 51 by being hydraulically controlled, and by colliding a distal end of the piston 52a with a front end of the cart 51, the cart 51 is decelerated so that it is possible to apply a backward impact, that is, a deceleration.

The mechanical damper 19 is installed between the sled 11 and the yawing sled 14, as a breaking device to break a horizontal rotation of the yawing sled 14.

An operation of the vehicle-collision simulation testing apparatus according to the fourth embodiment described above is explained below.

When conducting a vehicle collision test by the vehicle-collision simulation testing apparatus according to the fourth embodiment, a speed of the cart 51, a decelerating force of the piston 52a in the decelerating device 52, and a position of the product under test 16 on the yawing sled 14 are set to predetermined values in advance, in order to replicate a temporal change (waveform) of a yawing angle from the design data of the cart 51 and the yawing sled 14 (weight, position of the center of gravity and the like) and an acceleration change and a change of the yawing angle in a collision time obtained from the full-scale collision test.

A target acceleration G is applied on the cart 51 and the decelerating device 52, the cart 51 moves forward at a predetermined speed, and when the cart 51 collides with the piston 52a of the decelerating device 52, the acceleration G at the time of a collision is applied on the product under test 16. The target acceleration G is then applied on the cart 51 by being decelerated at the time of collision with the piston 52a of the decelerating device 52, and thereafter, the yawing sled 14 conducts a yawing operation around the rotation axis 15 (the rotation shaft A). With the yawing operation on the yawing sled 14 and the product under test 16, the mechanical damper 19 is operated to break the rotation of the yawing sled 14. Therefore, the yawing sled 14 is rotated in the horizontal direction by a yawing angle θ, by which the yawing operation is applied on the product under test 16.

In this manner, in the vehicle-collision simulation testing apparatus according to the fourth embodiment, the cart 51 is supported in a movable manner in the back-and-forth direction, the front portion of the yawing sled 14 on which the product under test 16 can be mounted is supported on the cart 51 in a horizontally rotatable manner by the rotation shaft A, the eccentric mass 17 is provided on the side of the rotation shaft A on the yawing sled 14, and the decelerating device 52 that applies the forward acceleration is arranged on a rear side of the sled 11.

Therefore, it is possible to apply the yawing operation on the product under test 16 in the vehicle-collision simulation test simply by fixing the eccentric mass 17 at a predetermined position on the yawing sled 14, without providing an overhanging portion on the yawing sled 14 itself to cause an increase of the size of the apparatus, and as a result, it is possible to downsize the apparatus with lightweight.

### Fifth Embodiment

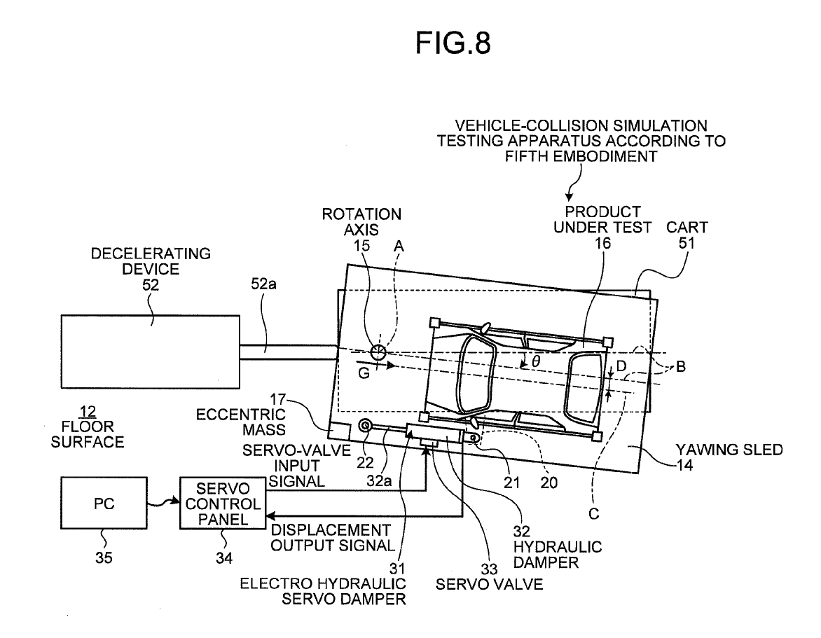

FIG. 8 is a plan view of a vehicle-collision simulation testing apparatus according to a fifth embodiment of the present invention. Members having functions identical to those described in the above embodiments are denoted by like reference numerals and redundant explanations thereof will be omitted.

As shown in FIG. 8, in the vehicle-collision simulation testing apparatus according to the fifth embodiment, the cart 51 is capable of moving back and forth on the floor surface 12 by four wheels 51a (see FIG. 6). The yawing sled 14 is arranged on the cart 51, with a front portion supported by the cart 51 via the rotation axis 15 so that it can make a rotation in the horizontal direction around the rotation shaft A. The product under test 16 can be mounted on an upper surface of the yawing sled 14 with a predetermined offset amount D.

The eccentric mass 17 is provided on the yawing sled 14 on a side of the rotation axis 15 (the rotation shaft A). The eccentric mass 17 is fixed on the yawing sled 14 at a front end and at a side edge on the side where the product under test 16 is arranged in an offset state.

The decelerating device 52 is installed on a front side of the sled 11 and the yawing sled 14, as an accelerating device that applies a backward acceleration on the cart 51. The decelerating device 52 includes the piston 52a that is retracted in a direction opposite to the cart 51 by being hydraulically controlled, and by colliding a distal end of the piston 52a with a front end of the cart 51, the cart 51 is decelerated so that it is possible to apply a backward impact, that is, a deceleration.

The electrohydraulic servo damper 31 is installed between the cart 51 and the yawing sled 14, as a breaking device to break a horizontal rotation of the yawing sled 14. The electrohydraulic servo damper 31 is arranged on a side of the cart 51 where the product under test 16 is arranged in an offset state. The electrohydraulic servo damper 31 includes the hydraulic damper 32 and the servo valve 33. The servo valve 33 is connected to a control device (a computer or PC) 35 via the servo control panel 34.

A target acceleration G is applied on the cart 51 and the decelerating device 52, the cart 51 moves forward at a predetermined speed, and when the cart 51 collides with the piston 52a of the decelerating device 52, the acceleration G at the time of a collision is applied on the product under test 16. The target acceleration G is then applied on the cart 51 by being decelerated at the time of collision with the piston 52a of the decelerating device 52, and thereafter, the yawing sled 14 conducts a yawing operation around the rotation axis 15 (the rotation shaft A). At this time, the control device 35 controls the electrohydraulic servo damper 31 to replicate the temporal change (waveform) of the yawing angle, adjusts a breaking force of the hydraulic damper 32 by adjusting an opening of the servo valve 33 via the servo control panel 34, and breaks the yawing sled 14 in an appropriate manner to apply the yawing operation on the product under test 16 such that the yawing sled 14 is rotated in the horizontal direction by a yawing angle θ.

As described above, in the vehicle-collision simulation testing apparatus according to the fifth embodiment, the cart 51 is supported in a movable manner in the back-and-forth direction, the front portion of the yawing sled 14 on which the product under test 16 can be mounted is supported on the cart 51 in a horizontally rotatable manner by the rotation shaft A, the eccentric mass 17 is provided on the side of the rotation shaft A on the yawing sled 14, the decelerating device 52 that applies the forward acceleration is arranged on the forward side of the sled 11, and the electrohydraulic servo damper 31 is installed as a breaking device to break a horizontal rotation of the yawing sled 14.

Therefore, it is possible to apply the yawing operation on the product under test 16 in the vehicle-collision simulation test simply by fixing the eccentric mass 17 at a predetermined position on the yawing sled 14, without providing an overhanging portion on the yawing sled 14 itself to cause an increase of the size of the apparatus, and as a result, it is possible to downsize the apparatus with lightweight. Furthermore, it is possible to apply an optimum yawing operation on the product under test 16 by the electrohydraulic servo damper 31, and as a result, it is possible to enhance the accuracy of the test.

### Sixth Embodiment

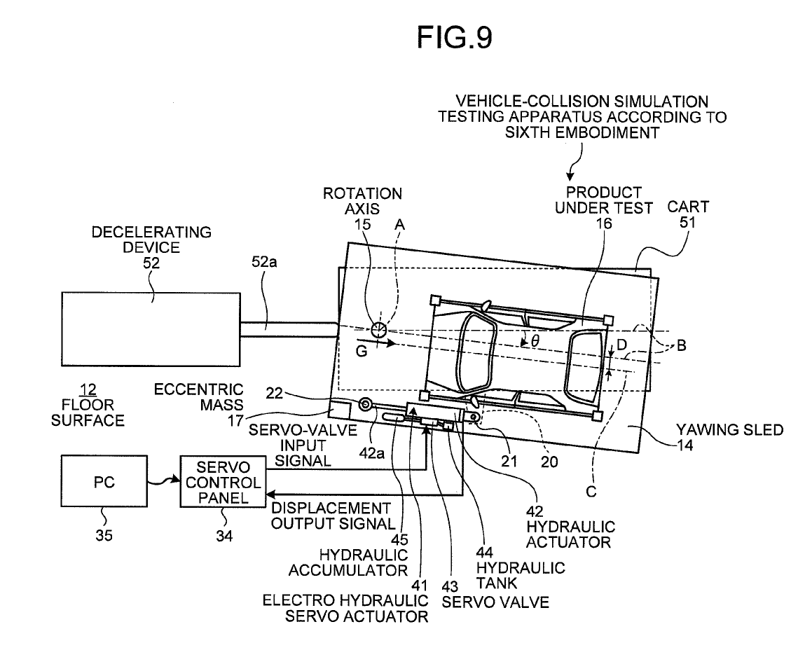

FIG. 9 is a plan view of a vehicle-collision simulation testing apparatus according to a sixth embodiment of the present invention. Members having functions identical to those described in the above embodiments are denoted by like reference numerals and redundant explanations thereof will be omitted.

As shown in FIG. 9, in the vehicle-collision simulation testing apparatus according to the sixth embodiment, the cart 51 is capable of moving back and forth on the floor surface 12 by four wheels 51a (see FIG. 6). The yawing sled 14 is arranged on the cart 51, with a front portion supported by the cart 51 via the rotation axis 15 so that it can make a rotation in the horizontal direction around the rotation shaft A. The product under test 16 can be mounted on an upper surface of the yawing sled 14 with a predetermined offset amount D. The eccentric mass 17 is provided on the yawing sled 14 in a side direction of the rotation axis 15 (the rotation shaft A).

The decelerating device 52 is installed on a front side of the sled 11 and the yawing sled 14, as an accelerating device that applies a backward acceleration on the cart 51. The decelerating device 52 includes the piston 52a that is retracted in a direction opposite to the cart 51 by being hydraulically controlled, and by colliding a distal end of the piston 52a with a front end of the cart 51, the cart 51 is decelerated so that it is possible to apply a backward impact, that is, a deceleration.

The electrohydraulic servo actuator 41 is installed between the cart 51 and the yawing sled 14, as a rotational-force applying unit that can apply a rotational force on the yawing sled 14. The electrohydraulic servo actuator 41 is arranged on a side of the sled 11 where the product under test 16 is arranged in an offset state, including a hydraulic actuator 42, the servo valve 43, the hydraulic tank 44, and the hydraulic accumulator 45. The servo valve 43 is connected to a control device (a computer or PC) 35 via the servo control panel 34. In addition, it is possible to use the electrohydraulic servo actuator 41 as a breaking device for the yawing sled 14.

A target acceleration G is then applied on the cart 51 and the decelerating device 52, the cart 51 moves forward at a predetermined speed, and when the cart 51 collides with the piston 52a of the decelerating device 52, the acceleration G at the time of a collision is applied on the product under test 16. At this time, the control device 35 controls the electrohydraulic servo actuator 41 in conjunction with an operation of the decelerating device 52 to replicate the temporal change (waveform) of the yawing angle. That is, the control device 35 adjusts a driving force of the hydraulic actuator 42 by adjusting an opening of the servo valve 43 via the servo control panel 34, and applies an appropriate rotational acceleration on the yawing sled 14. The target acceleration G is then applied on the cart 51 by being decelerated at the time of collision with the piston 52a of the decelerating device 52, and thereafter, the yawing sled 14 conducts a yawing operation around the rotation axis 15 (the rotation shaft A), by which the yawing sled 14 is rotated in the horizontal direction by a yawing angle θ.

As described above, in the vehicle-collision simulation testing apparatus according to the sixth embodiment, the cart 51 is supported in a movable manner in the back-and-forth direction, the front portion of the yawing sled 14 on which the product under test 16 can be mounted is supported on the cart 51 in a horizontally rotatable manner by the rotation shaft A, the decelerating device 52 that applies the forward acceleration is arranged on the forward side of the cart 51, and the electrohydraulic servo actuator 41 is provided between the cart 51 and the yawing sled 14, which applies a rotational force on the yawing sled 14 in conjunction with the decelerating device 52.

Therefore, it is possible to apply the yawing operation on the product under test 16 in the vehicle-collision simulation test by simply providing the electrohydraulic servo actuator 41 that applies a rotational force on the yawing sled 14, without providing an overhanging portion on the yawing sled 14 itself to cause an increase of the size of the apparatus, and as a result, it is possible to downsize the apparatus with lightweight. Furthermore, it is possible to apply an optimum yawing operation on the product under test 16 by the electrohydraulic servo actuator 41, and as a result, it is possible to enhance the accuracy of the test. In addition, it is possible to downsize the eccentric mass 17 installed on the yawing sled 14 with lightweight.

Although the product under test 16 is arranged in an offset state in the left direction on the yawing sled 14 in each of the embodiments described above, the vehicle-collision simulation testing apparatus according to the present invention is not limited thereto, and the product under test 16 can be arranged in an offset state in the right direction on the yawing sled 14.

Although the eccentric mass 17 is arranged on the upper surface of the yawing sled 14 as the eccentric weight unit in each of the embodiments described above, as long as it is a position that does not hinder the horizontal rotation of the sled 11 or the cart 51, the eccentric mass 17 can be arranged on a bottom surface or a front of a side surface of the yawing sled 14.

Although the eccentric weight unit (the eccentric mass 17), the rotational-force applying unit (the electrohydraulic servo actuator 41) are provided as a unit for applying the rotational force on the yawing sled 14 and the mechanical damper 19 and the electrohydraulic servo damper 31 are provided as the breaking device in each of the embodiments described above, they can be used in combination. In addition, the rotational-force applying unit is not limited to the electrohydraulic servo actuator 41.

### INDUSTRIAL APPLICABILITY

The vehicle-collision simulation testing apparatus according to the present invention makes it possible to downsize the apparatus with lightweight by installing the eccentric weight unit on a side of the rotation shaft on the yawing sled on which the product under test is mounted, and can be applied to any type of vehicle-collision simulation testing apparatus.

### REFERENCE SIGNS LIST

11 sled (pedestal)
12 floor surface
14 yawing sled
15 rotation axis
16 product under test
17 eccentric mass (eccentric weight unit)
18 launching device (accelerating device)
19 mechanical damper (breaking device)
31 electrohydraulic servo damper (breaking device)
32 hydraulic damper
33 servo valve
34 servo control panel
35 PC (control device)
41 electrohydraulic servo actuator (rotational-force applying unit)
42 hydraulic actuator
43 servo valve
44 hydraulic tank
45 hydraulic accumulator
51 cart (pedestal)
52 decelerating device (accelerating device)

1. A vehicle-collision simulation testing apparatus comprising:
a pedestal that is supported in a movable manner in a back-and-forth direction;
a yawing sled arranged on the pedestal in a horizontally rotatable manner with a front portion supported by a rotation shaft, on which a product under test can be mounted;
an eccentric weight unit arranged on a side of a rotation shaft on the yawing sled; and
an accelerating device that applies a backward acceleration on a front side of the pedestal.

2. The vehicle-collision simulation testing apparatus of claim 1, wherein a substantially center position of the yawing sled in a left-and-right direction is supported in a horizontally rotatable manner around the rotation shaft.

3. The vehicle-collision simulation testing apparatus of claim 1, wherein the product under test is mounted at an offset position on a side on the yawing sled, and the eccentric weight unit is arranged on an end of a front side of the yawing sled in a direction of offsetting the product under test.

4. The vehicle-collision simulation testing apparatus of claim 1, wherein the yawing sled is formed in a rectangular shape, and the eccentric weight unit is fixed within an upper surface of the yawing sled.

5. The vehicle-collision simulation testing apparatus of claim 1, further comprising a breaking device that breaks a horizontal rotation of the yawing sled.

6. The vehicle-collision simulation testing apparatus of claim 1, wherein the breaking device includes a damper.

7. The vehicle-collision simulation testing apparatus of claim 1, wherein the breaking device include a hydraulic damper and a control device that hydraulically controls the hydraulic damper in response to an operation of the accelerating device.

8. The vehicle-collision simulation testing apparatus of claim 1, further comprising: a rotational-force applying unit that can apply a rotational force on the yawing sled; and a control device that operates the rotational-force applying unit in conjunction with an operation of the accelerating device.
